(19) United States
(12) Patent Application Publication
(10) Pub. No.: US 2010/0258701 A1
(43) Pub. Date: Oct. 14, 2010

(54) Adjustable user support apparatus for exercise equipment

(76) Inventor: Glenn Foreman, Rayne, LA (US)

Correspondence Address: Glenn Foreman, 311 N. Parkerson St., Rayne, LA, 70578, US

(21) Appl. No.: 12/384,995

(22) Filed: Apr. 13, 2009

(51) Int. Cl. F16M 11/28

(52) U.S. Cl. 248/408

(57) ABSTRACT

An adjustable user support apparatus for exercise equipment has a lever driven adjustable user support which can be unlocked, adjusted to a user desired adjustment location and locked in the desired location. The preferred embodiment has a user support attached to an elongate member having a longitudinal central axis situated along a line of desired adjustment, a structure capable of holding the elongate member in alignment with the central axis, the structure allowing the elongate member to move only in a slideable fashion along the central axis, lever means for driving the elongate member in a slideable fashion along the central axis, and means for locking said elongate member in a user selectable position, wherein lever means and means for locking can be operated simultaneously with one hand.

### BACKGROUND

This invention relates to exercise equipment, specifically to adjustment mechanisms for user supports utilized on such exercise equipment.

Exercise equipment necessarily uses various types of user supports in order to assist users in acquiring and maintaining the proper position on the equipment for the specific activity for which the equipment was designed. These user supports typically include seats, back supports, chest supports, leg supports, foot platforms, and other supports well known to those familiar with the art. Because of the wide variety of size and shape of users which must be accommodated by exercise equipment, adjustment mechanisms are called for to allow for the necessary adjustment of the various user supports provided on the equipment.

Various types of adjustment mechanisms are known in the art, but none of the known adjustment mechanisms provide for all of the features that are most desirable in such a mechanism. It is very desirable that a user support mechanism for exercise equipment have smoothness and ease of operation, because most of this type of equipment is heavily used and requires frequent adjustment according to the size and shape of the user. It is also desirable that the adjustment be durable so that it is able to withstand this heavy usage without breakdown or undue maintenance. A further requirement is that the adjustment mechanism provides a secure and stable support for the user, and not be loose or wobbly when being used. It is also desirable that such mechanisms have adequate range of adjustment in order to accommodate the range of possible users from the smallest female to the largest male. Additionally, the adjustment mechanism should be low in cost, because the exercise and sporting equipment industry is very competitive, and expensive adjustment mechanisms cut into profitability.

Linear adjustments are desirable and well known in the art, and are of several types. One known type of linear adjustment has the user support attached to a frame which houses linear bearings which engage and slide on hardened shafts mounted on another frame, combined with a locking mechanism to selectively lock the adjustment into position. While these adjustments are typically very smooth and easy to operate, they are expensive to manufacture because linear bearings and the hardened shafts upon which they slide are expensive. They are also expensive to maintain because the shafts have to be cleaned and lubricated regularly or they can become scarred requiring replacement of both shafts and bearings. Even with proper care, these parts will require periodic replacement because the linear bearings use steel ball bearings which will eventually wear the steel shafts on which they roll.

Another type of user support adjustment mechanism which is well known in the art is the four bar linkage adjustment. Although such adjustments can be easy to operate, they are typically heavy because there is a lot of structure required in a four bar linkage in order to make them reasonably secure. Attempts to lighten the construction of such mechanisms typically result in a wobbly and unstable support. Due to the weight, it often becomes necessary to add an expensive gas spring to the mechanism as a counterbalance. Because of the amount of structure required, these mechanisms also usually become expensive to manufacture. Another disadvantage of the four bar linkage mechanism is that it does not move in a purely linear direction, but rather moves in an arc, which can be problematic when trying to keep a user properly positioned. Additionally, the use of four bar linkage adjustment mechanisms usually requires a more complicated and stronger mechanism for locking the adjustment into position.

A well known type of user support adjustment mechanism is a ratcheting adjustment where the user support selectively engages one or more of a series of grooves or gear teeth on a linear frame member. While this type of mechanism is usually simple and inexpensive to manufacture, it is difficult to operate by the user, and can be quite wobbly and unstable in use, and usually becomes more unstable, as it becomes worn from use. Depending on the type of user support, this adjustment can be quite heavy, is not capable of being counterbalanced, and requires considerable strength and dexterity to operate.

Another user support adjustment mechanism that is known in the art utilizes wheels or rollers that engage a shaft or tube externally, or that engage a tube internally. These adjustments require the use of multiple wheels, which often have to be specially engineered to properly fit the geometry of the shaft or tube that they are designed to engage. These wheels have to engage the shaft or tube in multiple locations in order to provide adequate stability, and also can require some additional type of tensioning device as well. Because of the complexity usually present in this type of adjustment mechanism, it is not particularly durable, can require a lot of maintenance, and is relatively expensive to manufacture. This adjustment mechanism can become quite heavy and may also require an expensive gas spring to counterbalance the weight in order to provide for ease of operation. An example of this type of user support adjustment mechanism is evidenced in U.S. Pat. No. 7,364,535 to Rosenow and Monsrud (2008).

A user support adjustment mechanism well known in the art is the telescoping adjustment mechanism whereby an inner shaft or tube is placed telescopically within an outer tube, and adjusts selectively within a certain range of the relative lengths of the inner and outer shaft and tube. Typically these telescoping tubing mechanisms lack ease of operation because they bind when trying to adjust because the force cannot be applied axially along the centerline of the telescoping tubing. The usual remedy for elimination of the problem of binding in this type of adjustment has been to add a gas spring to the mechanism to provide this axial force, but this has the disadvantage of adding significant additional expense to the mechanism.

Consequently, all of these mechanisms known in the prior art have some or all of the disadvantages of being difficult to use, costly to manufacture, unstable, or expensive to maintain.

### SUMMARY

In accordance with the invention, a stable, inexpensive and easy to operate user support adjustment mechanism is provided by attaching a user support to an elongate member which slides within a housing by virtue of a manually operated lever which directs the force in line with the central axis of the elongate member, and by providing a means of locking the elongate member in a position selected by the user. Because the force from the lever is directed in line with the central axis of the elongate member, binding is eliminated, and it is easy to operate. The mechanical advantage of the lever eliminates the need for any expensive additional components such as gas springs, linear bearings and roller wheels.

In particular embodiments of the invention, a low friction material can be interposed between the elongate member and the housing in order to provide a stable and tight fit while still providing ease of operation and low cost. Also in particular embodiments of the invention, the locking means can be operable by a linkage attached to the lever thereby allowing the user to easily unlock, adjust and lock the user support in the selected position while only using one hand in the operation.

### BRIEF DESCRIPTION OF THE DRAWINGS

FIG. 1 depicts a user support adjustment mechanism embodying the principles of the present invention;

FIG. 2 depicts a section view of a user support adjustment mechanism embodying the principles of the present invention, illustrating the locking means in an unlocked condition and the elongate member in an intermediate position; and

FIG. 3 depicts a section view of a user support adjustment mechanism embodying the principles of the present invention, illustrating the locking means in a locked condition and the elongate member in an extended position.

### DETAILED DESCRIPTION

Exercise equipment such as weight machines and weight benches typically require several types of user supports in order to allow the user to properly position himself while engaging in the exercise for which the equipment is designed. Among these supports are seats, seat backs, chest pads, foot rests, thigh supports, roller pads, and others that will be familiar to those skilled in the art. Because of the great variety in sizes of users, it is often necessary to design these supports to be adjustable. Due to the competitive nature of this art, it is desirable that these adjustments be user friendly and inexpensive.

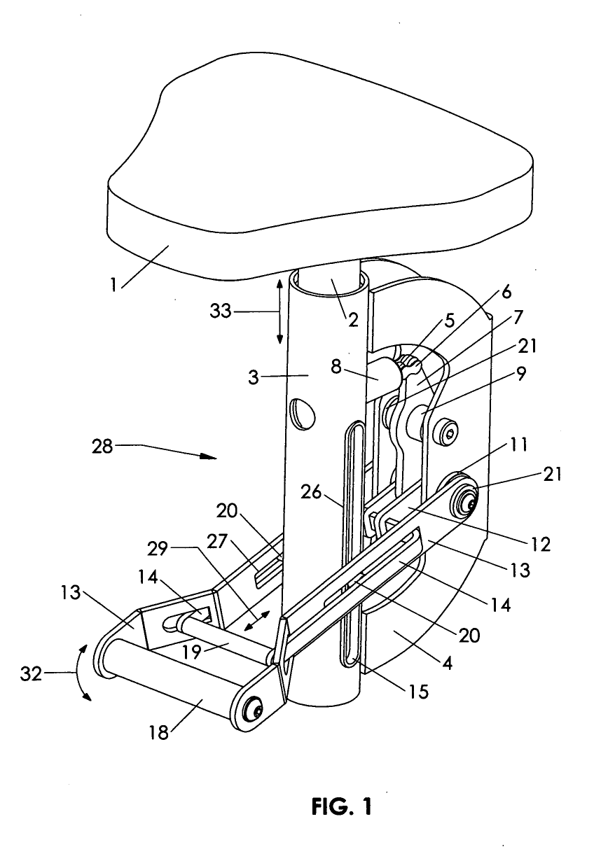

FIG. 1 depicts a user support adjustment mechanism embodying the principles of the present invention that is more user friendly and inexpensive than those known in the prior art while still providing the stability required.

The adjustment mechanism 28 comprises a user support 1 attached to an elongate member 2. In the orientation depicted where the axis of the elongate member 2 is substantially vertical, the user support 1 would typically serve as a “seat” used to support the users buttocks in a seated position, but it can be readily seen that the mechanism could be oriented to where the elongate member is substantially horizontal and the user support 1 could then serve as a chest pad, a back pad, or a hip pad. Likewise, the mechanism could be inverted to where the elongate member is again substantially vertical, wherein the user support could serve as a thigh or hip hold-down pad to keep the user from rising up during certain exercises. The user support 1 in these illustrative examples is typically made of a padded material such as upholstered foam, or integral skin foam, but could be made from any desired material. The user support 1 can also be configured as a foot rest or platform (not shown), in which case, it could be made from any desired material, typically having some kind of non-slip feature incorporated into its surface. It will also be apparent to one skilled in the art that the shape of the user support 1 can be any desired shape that will adequately provide comfort and support to the user, and does not necessarily have to be the shape illustrated in FIG. 1. In accordance with the principles of the invention, the elongate member 2 can be made of any desired material having the necessary strength to support the user as needed in the particular application as applied, many materials being available, because as used, the elongate member is compressed along its longitudinal axis when providing support to the user. In the preferred embodiment the elongate member is a steel tube of round cross section, however it can be readily seen that it need not be a tube, as a solid shaft would work just as well, and it need not have a round cross section, as other geometrical cross sections, such as square, rectangular, oval, and others would function perfectly also.

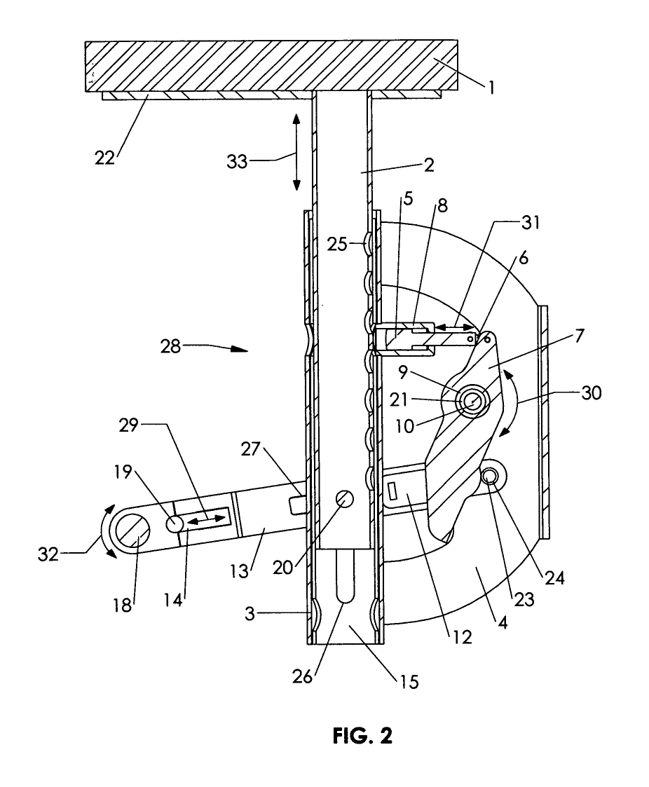

According to the principles embodied in the invention, elongate member 2 is restricted to movement along its longitudinal axis by virtue of a structure which in the case of the preferred embodiment depicted is a housing 3, which in the preferred embodiment shown in FIG. 1, is a tubular member having a cross section of similar shape of the elongate member, but is large enough for the elongate member to fit telescopically within housing 3. The fit of elongate member 2 within housing 3 is such that elongate member 2 is free to move along its longitudinal axis, but is adequately supported by housing 3 to prevent instability of the user support 1. Housing 3 may be made of any desired material of adequate strength for the support required in the particular application used; in the preferred embodiment steel is used. In accordance with an advantageous feature of the invention, though not necessary for its function, and as can be seen from FIG. 2, a bushing 15 made of a lower friction material may be interposed between elongate member 2 and housing 3 in order to provide a better fit and more ease of movement between them. Typically, the bushing 15 will be made of a polymer material, but could be made of any desired material having the characteristics of high strength and low friction needed to provide the ease of movement and stability required for the support application intended. The bushing material 15 may be one piece, or multiple pieces interposed between the elongate member 2 and housing 3.

An aspect of the design of the mechanism as shown in FIG. 2, is how the user support 1 is attached to the elongate member 2. In the case of the preferred embodiment shown, the user support pad 1 is removably attached to a mounting plate 22 which is fixedly attached to elongate member 2. In the preferred embodiment shown, user support 1 is attached to mounting plate 22 with screws or bolts (not shown) in order to facilitate replacement of the user support due to normal wear and tear. Mounting plate 22 is permanently affixed to elongate member 2 in the preferred embodiment by welding, but other means of permanent attachment may be used depending on the materials chosen for the particular embodiment of the invention selected. Additionally, some user supports may not require a plate, but may alternatively require other mounting means, such as roller pad shafts or tubes, foot rest supports, or other support structure as will be familiar to those skilled in the art, as long as the user support is attached to the elongate member 2.

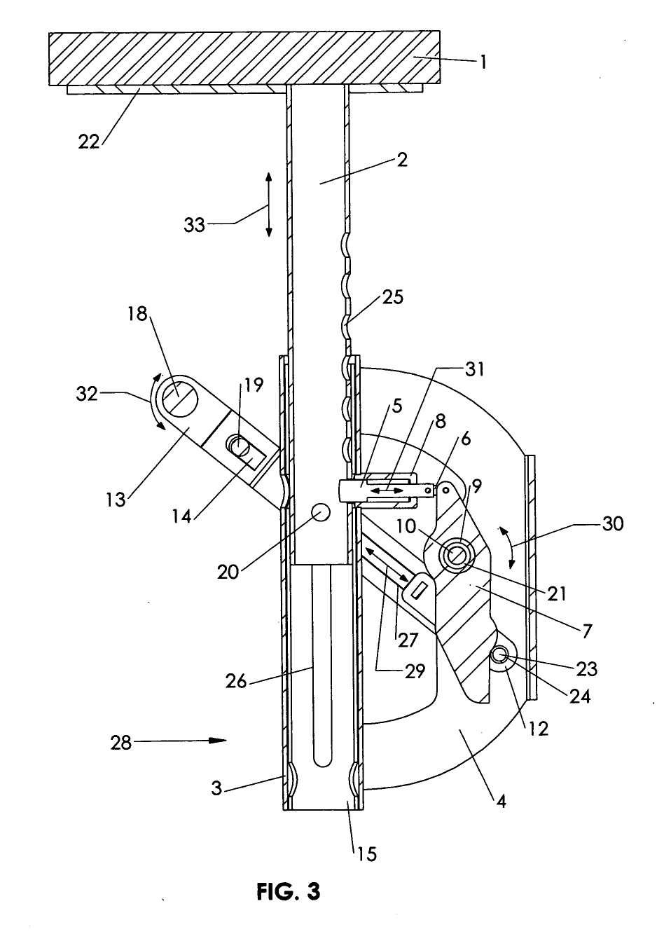

Referring to FIG. 3 means for locking elongate member 2 in a desired position of adjustment is comprised of a plurality of holes 25 in the wall of the elongate member which are aligned with and selectively engaged by pin 5 which is extended through openings provided in housing 3 and bushing 15. Pin 5 is held in place by pin housing 8 affixed to housing 3 and is extended by pressure from spring 34 through one of holes 25 thereby locking elongate member 2 relative to housing 3. Pin 5 moves along direction 31 during extension and retraction to perform locking and unlocking of elongate member 2. FIG. 3 shows pin 5 retracted against pressure of spring 34. In the preferred embodiment of the invention, referring to FIG. 1 operation of the locking means by extension and retraction of pin 5 is performed by the user moving locking handle 19 back and forth along direction 29. Locking handle 19 is attached to first end of locking handle guide bar 14. A first end of each of locking lever actuator bars 12 are attached to second end of locking handle guide bar 14 opposite end of locking handle guide bar to which locking handle 19 is attached. A second end of each of locking lever actuator bars 12 are connected by actuator pin 23 extending between each of said second end of locking lever actuator bars 12. Actuator bushing 24 fits over actuator pin 23 in between second end of each of locking lever actuator bars 12. In the preferred embodiment, actuator bushing 24 is made of a durable low friction polymer designed to aid in ease of operation of locking means, but could be made of other low friction materials, or even be dispensed with altogether as it is not essential for the operation of the invention. Locking handle guide bar 14 is held in position relative to lever arms 13 by lever arm guide slots 27 which allow slideable movement of locking handle guide bar back and forth in direction 29. Lever arm guide slots 27 are an illustrative feature of the invention, as other means of guiding the locking handle guide bar's movement could be provided within the principles of the invention. Lever handle 18 is removably connected to lever arms 13 at a first end of each lever arm. In the preferred embodiment, the lever handle is connected to the lever arms by virtue of bolts 16 and washers 17, but this connection can be made by any removable means well known to those skilled in the art. A mounting bracket 4 is connected to housing 3 in order to provide a structure for attachment of other features illustrative of the present invention, as well as for providing a structure for attachment of the invention to an exercise machine on which it is used. In the preferred embodiment shown, mounting bracket 4 is shaped sheet metal formed in a configuration which allows its attachment to housing 3 near each end of housing 3 in order to provide the maximum strength and support to housing 3 and therefore to elongate member 2 and user support 1 which are in turn slideably contained in housing 3. Mounting bracket 4 is also configured to provide attachment structure for each of second ends of lever arms 13, mounting bracket 4 therefore providing said attachment structure relative to lever arms 13 and housing 3 such that lever arms 13 are held in close proximity to and on either side of housing 3, and such that with said second ends of lever arms 13 pivotally attached to mounting bracket 4, lever arms 13 are able to pivot in direction 32. Mounting bracket 4 also provides structure for pivotally attaching pin linkage lever 7 within mounting bracket such that a first end of pin linkage lever 7 is aligned with pin 5 and attached to pin 5 by link 6. Pin linkage lever 7 is pivotally attached to mounting bracket 5 by shoulder bolt 10 extending through mounting bracket 5 and pin linkage lever pivot housing 9 and pin linkage lever bushing 21 which are attached to pin linkage lever 7 allowing pin linkage lever 7, referring to FIG. 2, to pivot in direction 30 about shoulder bolt 10 when actuator pin 23 and actuator bushing 24 exert force on rear lower edge of pin linkage lever 7 as a result of user moving locking handle 19 in direction 29 pulling on actuator pin 23 and actuator bushing 24 connected to locking handle 19 by locking actuator bars 12. Referring to FIG. 3, releasing locking handle 19 allows pin 5 to extend by pressure of spring 34 back into locking position by engaging one of holes 25. Referring again to FIG. 2, holding locking handle 19 in the unlocked position whereby pin 5 is retracted out of holes 25, allows user to move lever handle 18 attached to lever arms 13 pivotally about, referring to FIG. 1, lever pivots 17 which are attached to mounting bracket 5 by bolts 16. Lever bushings 21 provide low friction pivoting surface between lever arms 13 and lever pivots 17. Referring to FIG. 2, driving pin 20 is attached transversally through elongate member 2 and is aligned with and extends through housing slots 26 on either side of housing 3. Referring to FIG. 1, housing slots 26 are of a length sufficient to allow driving pin 20 to move within said slots enabling pin 5 to selectively engage each of holes 25 in elongate member 2. Housing slots 26 are also large enough to allow flange of bushing 15 to be interposed between housing slots 26 and driving pin 20. Driving Pin 20 extends far enough from either side of elongate member 2 to pass through lever arm guide slots 27 on each of lever arms 13 on either side of housing 3. Consequently, when user pivots lever arms 13 by moving lever handle 18 in direction 32, lever arm guide slots 27 exert force on drive pin 20 thereby moving elongate member 2 in direction 33 within housing 3 and bushing 15, and also thereby moving user support 1 in direction 33 to a desired position. When a desired position of user support 1 is achieved, user releases locking handle 19 to allow pin 5 to selectively engage one of holes 25, thereby locking elongate member 2 and attached user support 1 into the desired position. It can be readily seen that this entire operation is easily accomplished by one hand of user grasping lever handle 18 with the palm and thumb of the hand and operating locking handle 19 with the fingers of the hand while moving the hand in direction 32 to desired adjustment position for user support 1.

A user support adjustment mechanism as described in the foregoing description can be made from any desired materials having the necessary strength to support the user for the application desired. The present inventor has found that steel, aluminum, castings, and other metals as well as composites are sufficiently strong for use in embodiments of this invention. An aspect of the design of the invention is how to hold all of the parts together. It is clear to one skilled in the art that a variety of attachment means could be used including, but not limited to, welding, adhesives, and use of fasteners, and the use of those shown in the above described embodiment are merely illustrative and not limiting.

The foregoing merely illustrates the principles of the invention. It will thus be appreciated that those skilled in the art will be able to devise numerous alternative arrangements that, while not shown or described herein, embody the principles of the invention and thus are within its spirit and scope.

What is claimed is:

1. Apparatus comprising
a user support, said user support attached to an elongate member having a longitudinal central axis situated along a line of desired adjustment, a housing capable of holding the elongate member in alignment with the central axis, said housing allowing the elongate member to move only in a slideable fashion along the central axis, a manually operable lever capable of exerting a force upon the elongate member in line with the central axis, and means for locking said elongate member in a user selectable position.

2. The apparatus of claim 1 wherein the means for locking includes a plurality of holes provided in the elongate member which are aligned with a spring-loaded retractable and extendable pin mounted to the housing such that when the pin is extended into one of the plurality of holes of the elongate member, the elongate member is prevented from moving in relation to the housing, and when the pin is retracted out of the plurality of holes, the elongate member is allowed to move along the central axis in relation to the housing.

3. The apparatus of claim 1 wherein the means for locking includes a plurality of holes provided in the elongate member which are aligned with a spring-loaded retractable and extendable pin mounted to the housing such that when the pin is extended into one of the plurality of holes of the elongate member, the elongate member is prevented from moving in relation to the housing, and when the pin is retracted out of the plurality of holes, the elongate member is allowed to move along the central axis in relation to the housing, and means for retracting and extending the spring-loaded retractable and extendable pin remotely from a handle attached to the manually operable lever.

4. The apparatus of claim 1 wherein the manually operable lever and the means for locking can be operated simultaneously with one hand.

5. Apparatus comprising
a user support, said user support attached to an elongate member having a longitudinal central axis situated along a line of desired adjustment, a structure capable of holding the elongate member in alignment with the central axis, said structure allowing the elongate member to move only in a slideable fashion along the central axis, lever means for driving the elongate member in a slideable fashion along the central axis, and means for locking said elongate member in a user selectable position.

6. The apparatus of claim 5 wherein lever means and means for locking can be operated simultaneously with one hand.

7. The apparatus of claim 5 wherein the user support is a seat.

8. The apparatus of claim 5 wherein the user support is a roller pad.

9. The apparatus of claim 5 wherein the user support is a back pad.

10. The apparatus of claim 5 wherein the user support is a chest pad.

11. The apparatus of claim 5 wherein the user support is a foot rest.

12. The apparatus of claim 5 wherein the user support is a platform.

13. The apparatus of claim 5 wherein the user support is a hip pad.

14. The apparatus of claim 5 wherein the user support is a thigh pad.

15. Apparatus comprising
a user support, said user support attached to an elongate member having a longitudinal central axis situated along a line of desired adjustment, a structure capable of holding the elongate member in alignment with the central axis, said structure allowing the elongate member to move only in a slideable fashion along the central axis, said elongate member further comprising a drive pin mounted transversely through said longitudinal central axis of elongate member, lever means for engaging said drive pin thereby driving the elongate member in a slideable fashion along the central axis, and means for locking said elongate member in a user selectable position.

16. The apparatus of claim 15 wherein lever means and means for locking can be operated simultaneously with one hand.

17. The apparatus of claim 15 wherein the user support is a seat.

18. The apparatus of claim 15 wherein the user support is a roller pad.

19. The apparatus of claim 15 wherein the user support is a back pad.

20. The apparatus of claim 15 wherein the user support is a chest pad.

21. The apparatus of claim 15 wherein the user support is a foot rest.

22. The apparatus of claim 15 wherein the user support is a platform.

23. The apparatus of claim 15 wherein the user support is a hip pad.

24. The apparatus of claim 15 wherein the user support is a thigh pad.
